(19) United States
(12) Patent Application Publication
(10) Pub. No.: US 2024/0312045 A1
(43) Pub. Date: Sep. 19, 2024

(54) Establishing Interactions Between Dynamic Objects and Quasi-Static Objects

(71) Applicant: Juganu Ltd., Or-Yehuda (IL)

(72) Inventors: Dani Fichman, Raanana (IL); Alexander Bilchinsky, Ganey-Tikva (IL); Eran Ben-Shmuel, Savyon (IL); Gal Zuckerman, Holon (IL)

(21) Appl. No.: 18/184,983

(22) Filed: Mar. 16, 2023

(51) Int. Cl. G06T 7/70; G06T 7/13; G06T 7/20; G06T 17/20; G06V 10/764

(52) U.S. Cl. CPC G06T 7/70; G06T 7/13; G06T 7/20; G06T 17/20; G06V 10/764; G06V 2201/07

(57) ABSTRACT

System and methods for detecting, analyzing, and understanding various events involving dynamic objects interacting with static/quasi-static objects. A plurality of edge devices first conduct a visual survey of a certain indoor and/or outdoor area over a certain period of time to detect quasi-static object that do not substantially move during that certain period of time. The quasi-static objects are then classified for functional purpose and geometrically dimensioned/geo-spatially positioned. The edge devices then conduct a real-time visual survey to detect, classify, and dimension/position different types of dynamic objects, such as pedestrians and vehicles. The information obtained on the dynamic objects is then combined using geo-spatial parameters/common coordinate system with the information obtained on the quasi-static object to identify/classify events such as pedestrians using a crosswalk to cross a street, vehicles parking in designated parking areas, and shoppers entering stores.

### TECHNICAL FIELD

This application relates generally to image processing and machine learning.

### BACKGROUND

In outdoor and indoor environments, many types of objects are clearly visible from many angles, in which some of the objects are considered static or quasi-static, such as structures and vegetation, and some of the objects are considered dynamic, such as vehicles and pedestrians. In such outdoor and indoor environments, it may be important to detect certain events that involve static and dynamic objects.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

One embodiment is a system operative to generate geo-temporal descriptions of dynamic objects and associate the geo-temporal descriptions with quasi-static geo-functional descriptions of quasi-static objects in a certain area, comprising: a plurality of edge devices, each comprising at least one optical sensor operative to capture imagery data, in which the plurality of edge devices are located respectively at a plurality of different locations so as to result in at least partial visual coverage of the certain area; and a server associated with the edge devices; wherein the system is configured to: generate the quasi-static geo-functional descriptions of at least some of the quasi-static objects in the certain area using the imagery data captured by the edge devices and accumulated over a certain period of time; further generate, in real time, the geo-temporal descriptions of at least some of the dynamic objects using current imagery data captured by the edge devices; and associate said geo-temporal descriptions with the geo-functional description, thereby establish geo-temporal interactions of the dynamic objects with the quasi static objects in the certain area.

One embodiment is a method for generating geo-temporal descriptions of dynamic objects and associating the geo-temporal descriptions with quasi-static geo-functional descriptions of quasi-static objects in a certain area, comprising: generating, by a plurality of edge devices in the certain area and a server, quasi-static geo-functional descriptions of at least some of the quasi-static objects in the certain area using imagery data captured by the edge devices and accumulated over a certain period of time; further generating, in real time, geo-temporal descriptions of at least some of dynamic objects in the area using current imagery data captured by the edge devices; and associating said geo-temporal descriptions with the geo-functional description, thereby establishing geo-temporal interactions of the dynamic objects with the quasi static objects in the certain area.

### BRIEF DESCRIPTION OF THE DRAWINGS

For a fuller understanding of the nature and advantages of the concepts disclosed herein, reference is made to the detailed description of preferred embodiments and the accompanying drawings. The embodiments are herein described by way of example only, with reference to the accompanying drawings. No attempt is made to show structural details of the embodiments in more detail than is necessary for a fundamental understanding of the embodiments.

FIG. 1A illustrates one embodiment of an outdoor area comprising dynamic objects interacting with quasi-static objects and further comprising edge sensors operative to detect the various objects and related interactions.

FIG. 1B illustrates one embodiment of an edge device and associated components that are placed at a location facilitating good visibility of surrounding environment.

FIG. 1C illustrates one embodiment of the edge device communicating over a network with other edge devices and servers.

FIG. 2A illustrates one embodiment of a quasi-static object imagery and a representation derived from the quasi-static object imagery including three-dimensional and semantic information.

FIG. 2B illustrates one embodiment of a dynamic object imagery and a representation derived from the dynamic object imagery including motion vectors and semantic information.

FIG. 2C illustrates one embodiment of an association made between the dynamic and quasi-static objects at the semantic and geometric level.

FIG. 3 illustrates one embodiment of a method for generating geo-temporal descriptions of dynamic objects and associating the geo-temporal descriptions with quasi-static geo-functional descriptions of quasi-static objects in a certain area.

FIG. 4A illustrates one embodiment of a mobile device that is currently attached to one of a series of base stations and that is located in a moving vehicle that is being visually tracked along a path of progression.

FIG. 4B illustrates one embodiment of a base station associated with a visual sensor that is being used to visually track the vehicle containing the mobile device currently attached to the base station.

FIG. 4C illustrates one embodiment of the moving vehicle that has been visually tracked to a specific location that is known to be a good location for initiating a handover from the base station to which the mobile device is currently attached to an adjacent base station.

FIG. 4D illustrates one embodiment of handing over of the mobile device from one of the base stations to an adjacent base station while continuing with visually tracking the vehicle.

FIG. 4E illustrates one embodiment of the vehicle visually tracked to another location that is known to be a good location for initiating another handover to the next base station in the series.

FIG. 5 illustrates one embodiment of a method for utilizing visual cues to predict handover events in conjunction with radio-access-networks.

### DETAILED DESCRIPTION

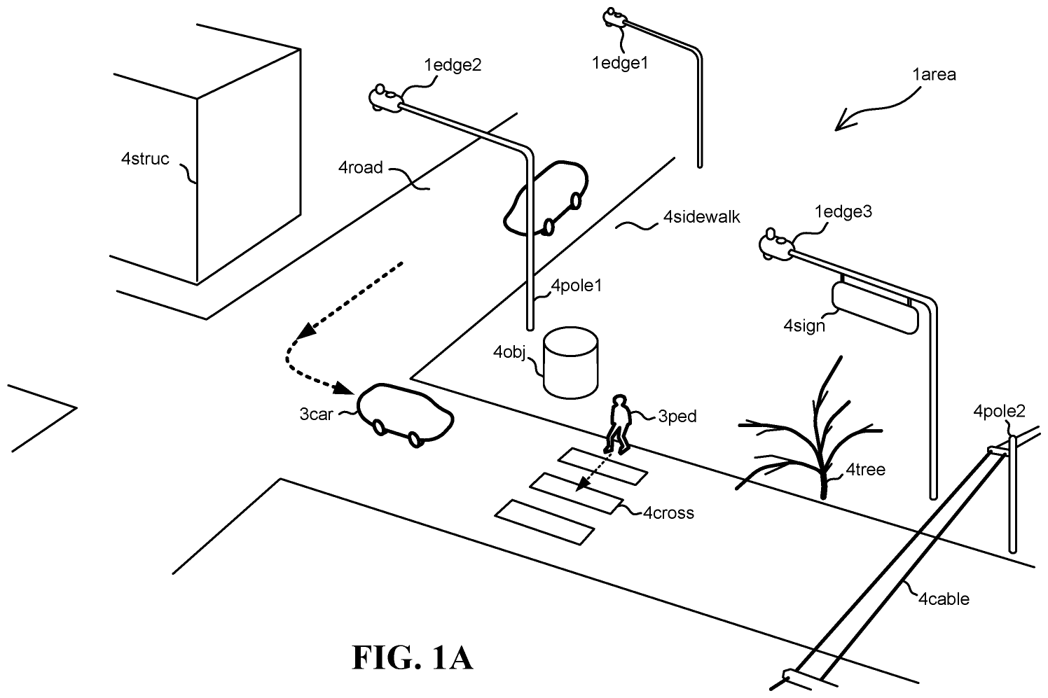

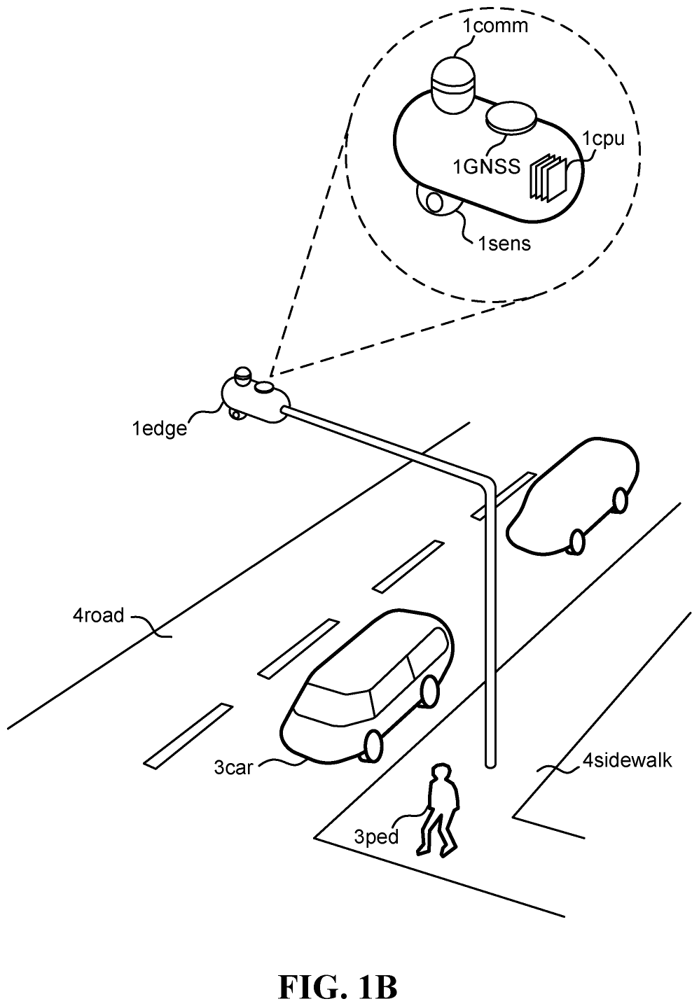

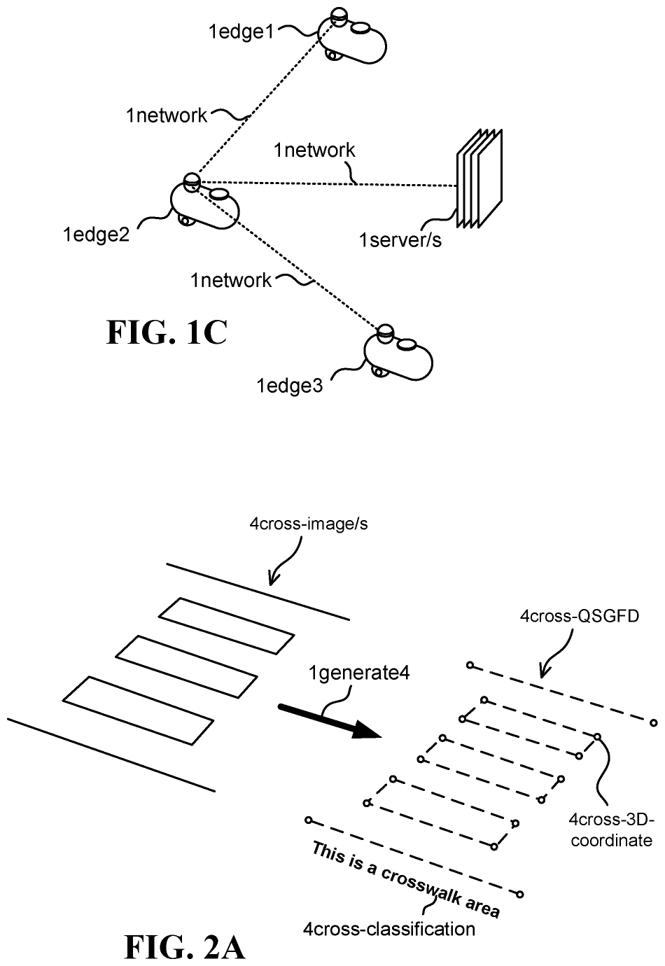

FIG. 1A illustrates one embodiment of an outdoor area 1area comprising dynamic objects interacting with quasi-static objects and further comprising edge sensors operative to detect the various objects and related interactions. Area 1area includes dynamic objects such as vehicles 3car and pedestrians 3ped, as well as quasi-static objects such as buildings 4struc and other structures 4obj, roads and streets 4road, sidewalks and trails 4sidewalk, crosswalks and other on-road markings 4cross, trees and other vegetation 4tree, poles 4pole, signs 4sign, and cables 4cable. A quasi-static object is an object that is essentially stationary and does not shift position, but which may exhibit some local movement such as tree branches moving in the wind, or a pole getting bent over time. The area at hand 1area is depicted as being an outdoor area, but it may also be an indoor area, such as the interior of a shopping mall having quasi-static or static objects such as shops and benches, and dynamic objects such as shoppers moving around.

Several edge devices 1edge are shown, that include visual sensors operative to visually capture both the quasi-static objects and the dynamic objects. The edge devices 1edge are spread over the area of interest 1area so as to have good visibility of the various objects. For example, 1edge1 is located at a far end of the road 4road so as to visually capture vehicles entering the area of interest 1area, 1edge2 is located near an intersection so as to visually capture a nearby building 4struc with people entering/exiting, to visually capture a nearby crosswalk 4cross with pedestrians 3ped crossing, and to visually capture vehicles moving and parking nearby. Other edge devices 1edge3 may be used to completely cover the entire area of interest 1area.

It is noted that it may be beneficial to have a complete visual coverage of the entire area of interest 1area, but a partial visual coverage is also helpful, especially when not enough locations are available for placing the edge devices 1edge, either as a result of environmental conditions/considerations and/or other considerations such as cost of deployment and maintenance.

Edge devices 1edge are depicted as being located at elevated positions using poles, which is beneficial for better visual coverage of the area of interest 1area. However, the edge devices may be placed at the street level or other levels, or may be elevated using other arrangements than poles, e.g., using buildings and other structures. The edge devices 1edge may be standalone devices, or they may piggyback other devices such as traffic lights, street illumination devices, surveillance equipment, signs, cellular base stations, and/or other stationary infrastructure.

Each of the dynamic and quasi-static (or completely static) objects may be visually captured by only one of the edge devices 1edge or may be visually captured by several of the edge devices. For example, crosswalk 4cross may be visually captured by both 1edge2 and 1edge3, providing many benefits such as better combined resolution and triangulation capabilities that may add accuracy to determining geo-positions and geometric dimensions of the crosswalk.

Some of the quasi-static objects, such as a road 4road, may extend over relatively long distances and therefore come in and out of several fields of view of the different edge devices 1edge. For example, 1edge1 may be able to see only the beginning of road 4road, 1edge2 may be able to see only the intersection part of road 4road, and 1edge3 may be able to see only the end of road 4road, and therefore, the combined imagery data gathered from the three edge devices may be used to determine geo-positions and geometric dimensions of road road4. The geo-positions and geometric dimensions of road road4 may be determined accurately throughout the length of the road when the fields of view of adjacent edge devices overlap. In addition, the geo-positions and geometric dimensions of road road4 may be determined when there are gaps in visual coverage between adjacent edge devices, in which case extrapolation and machine-learning techniques may be utilized to close the visual gaps.

FIG. 1B illustrates one embodiment of an edge device 1edge and associated components that are placed at a location facilitating good visibility of surrounding environment. The edge device includes an optical sensor 1sens such as a visible light camera, an infrared camera, a lidar, an RGB (red-blue-green)-Depth sensor, and/or a stereo camera. The optical sensor is used to visually capture quasi-static objects (e.g., 4road, 4sidewalk) and dynamic objects (e.g., 3car, 3ped) surrounding the edge device. The edge device may further include a global navigation satellite system (GNSS) receiver 1GNSS such as a GPS (Global Positioning Service) receiver that is used to determine the geo-spatial coordinates of the edge device, a communication subsystem 1comm operative to communicatively connect the edge devices with other networked elements, and an onboard computer 1cpu operative to at least partially process imagery data captured by the optical sensor. The edge device 1edge is depicted as being mounted on a pole, but it may be mounted on other objects, or it may be placed at the street level.

FIG. 1C illustrates one embodiment of the edge device 1edge2 communicating over a network 1network with other edge devices 1edge1, 1edge3 and servers 1server/s. The network may be associated with a cellular network, a WiFi network such as a mesh network, a microwave/millimeter-wave backhaul, a satellite communication link, or a wired network such as Ethernet, fiber, or a telephone line. The network is depicted as related to a tree topology, but it may be related to other topologies such as a mesh topology or a star topology, and convey data using known communication methods such as packet switching or circuit switching, in a point-to-point, in a point-to-multipoint fashion, or in other fashions.

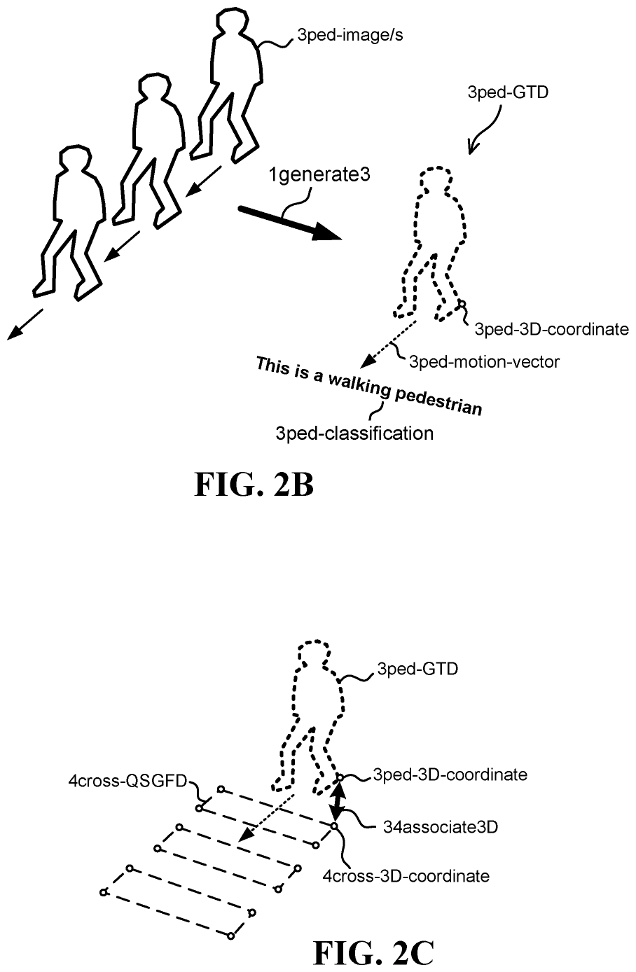

FIG. 2A illustrates one embodiment of a quasi-static object imagery and a representation derived from the quasi-static object imagery including three-dimensional and semantic information. The imagery 4cross-image/s was captured by one of the edge devices 1edge and is a depiction of a crosswalk 4cross, which is a quasi-static object. Quasi-static objects, by their nature, are subject to minimal movements, and therefore imagery 4cross-image/s may actually be a sequence of images taken by the edge device over a certain period of time that may be measured in seconds (e.g., more than one second), minutes (e.g., more than one minute), hours (e.g., more than one hour) or even days (e.g., more than one day) and/or weeks (e.g., more than one week). Capturing long image sequences of quasi-static objects may have several benefits, including the ability to “integrate” the images over a long period of time to “remove” dynamic/temporary visual obstructions such as, in the case of a crosswalk 4cross, caused by pedestrians 3ped crossing over and vehicles 3car passing above. Other benefits include improving spatial resolution using image-combining techniques such as super-resolution algorithms, resistance to changing lighting and atmospheric conditions (e.g., day/night, fog, rain, and/or sun blinding), and/or accounting for slow/minor changes to quasi-static objects over time.

After capturing sequences of a quasi-static object imagery, e.g., the sequence 4cross-image/s depicting a crosswalk 4cross, the sequences are processed using image processing and/or machine-learning techniques in order to generate 1generate4 a quasi-static geo-functional description (QSGFD) 4cross-QSGFD of the specific object, which is a way to describe the specific quasi static object from both a geometric perspective and a functional perspective. For example, from a geometric perspective, 4cross-QSGFD may describe a geometric location of the respective crosswalk 4cross: e.g., using a 3-dimensional (3D) representation of the crosswalk including 3D spatial coordinates 4cross-3D-coordinate, and/or using borders of the crosswalk 4cross as expressed in a known coordinate system such as the world geodetic system (WGS) used in cartography, geodesy, and satellite navigation including GPS, and/or using any other geometric location expression that maps the shape/boundaries of crosswalk 4cross into a reference coordinate system. From a functional perspective, 4cross-QSGFD may describe/classify 4cross-classification the respective crosswalk 4cross: e.g., identify 4cross-QSGFD as an area that is designated for pedestrians 3ped to cross the street 4road.

Any number of techniques may be used separately or in combinations to determine the geometry of a quasi-static object, including stereo vision from a single edge device 1edge2, RGB-Depth cameras from a single edge device, lidar sensors, and/or triangulation using two cameras on two adjacent edge devices: e.g., 1edge2 and 1edge3 may triangulate every geometric point of crosswalk 4cross that is visible to both. Additional more exotic techniques such as simultaneous localization and mapping (SLAM) may be used, in which a change in perspective is utilized to extract 3D information, wherein such a change in perspective may be achieved by considering visual inputs form several of the edge devices.

Any number of techniques may be used separately or in combinations to link a geometric description of a quasi-static object to a known coordinate system. One such technique is using a GPS receiver 1GNSS onboard an edge device1edge, or another method, to determine a location thereof, and then extrapolating the position of various parts of quasi-static objects using range/angle information extracted by the edge device using range finding techniques such as lidar, depth sensors, and stereo vision. Another such technique is to optically match/correlate imagery associated with the quasi-static object, or with the surrounding thereof, with a known visual database that includes references to a known coordinate system.

Any number of techniques may be used separately or in combinations to determine a functional purpose/classification of a quasi-static object, including machine learning/neural-network models operative to automatically classify different objects in a process known as inference, using manual approaches for tagging objects, and/or accessing a geographic information system (GIS) that may already include a functional description of elements on a map. When using machine learning/neural-network models, the inference process may be executed on a purely visual input such as 4cross-image/s, or on an already processed input such as 4cross-QSGFD that includes 3D information. Inferencing using 3D inputs may be more accurate sometimes, or even require a lesser degree of processing power, as compared to direct visual inference, depending on the nature of the quasi-static object and optical conditions.

In one embodiment, the generation 1generate4 of quasi-static geo-functional descriptions, such as the generation of 4cross-QSGFD, is done locally using a processor 1CPU onboard the edge device 1edge that is capturing the relevant sequences of imagery data 4cross-image/s. In such a case, the sequences of imagery data 4cross-image/s are aggregated and stored locally in the respective edge device for local machine learning/image processing.

In one embodiment, the generation 1generate4 of quasi-static geo-functional descriptions, such as the generation of 4cross-QSGFD, is done externally in a server 1server/s that is in communicative contact with the edge device 1edge that is capturing the relevant sequences of imagery data 4cross-image/s. In such a case, the sequences of imagery data 4cross-image/s are sent over a communication network 1network from the edge device to the server for machine learning/image processing.

In one embodiment, the generation 1generate4 of quasi-static geo-functional descriptions, such as the generation of 4cross-QSGFD, is done cooperatively both locally using a processor 1CPU onboard the edge device 1edge that is capturing the relevant sequences of imagery data 4cross-image/s and externally in a server 1server/s that is in communicative contact with the edge device. In such a case, for example, the geometric/positioning aspects of generating the quasi-static geo-functional descriptions may be done locally in the edge device, while the functional description aspects of generating the quasi-static geo-functional descriptions may be done in the server after receiving pre-processed and/or post-processed data from the edge device.

FIG. 2B illustrates one embodiment of a dynamic object imagery and a representation derived from the dynamic object imagery including motion vectors and semantic information. The imagery 3ped-image/s was captured by one of the edge devices 1edge and is a depiction of pedestrian 3ped, which is a dynamic/moving object. Dynamic objects, by their nature, are on the move, and therefore imagery 3ped-image/s is a sequence of images taken by the edge device, from which, for example, motion vectors can be derived. During, immediately after, or sometime after capturing the sequences of a specific dynamic object imagery, e.g., the sequence 3ped-image/s depicting a moving pedestrian, the sequences are processed using image processing and/or machine-learning techniques in order to generate 1generate3 a geo-temporal description 3ped-GTD of the specific object, which is a way to describe the dynamic object from both a geometric/temporal perspective and a functional perspective. For example, from a geometric/temporal perspective, 3ped-GTD may describe a geometrically changing-location of the respective pedestrian 3ped: e.g., using a 3D representation of the pedestrian including 3D spatial coordinates 3ped-3D-coordinate, and/or using a motion vector 3ped-motion-vector, and/or using any other dynamic geometric location expression that maps the shape/movement of pedestrian 3ped into a reference coordinate system. From a functional perspective, 3ped-GTD may describe/classify 3ped-classification the respective pedestrian 3ped: e.g., identify 3ped-GTD as a walking human.

Any number of techniques may be used separately or in combinations to determine geometric movement of a dynamic objects, including stereo vision from a single edge device 1edge2, RGB-Depth cameras from a single edge device, lidar sensors, and/or triangulation using two cameras on two adjacent edge devices: e.g., 1edge2 and 1edge3 may triangulate every geometric point of pedestrian 3ped, during its movement, that is visible to both.

Any number of techniques may be used separately or in combinations to link a geometric description of a dynamic object to a known coordinate system, in a similar fashion to linking geometric description of a quasi-static objects as described before, but with the difference of adapting location parameters to match movement vectors.

Any number of techniques may be used separately or in combinations to determine a functional purpose/classification of a dynamic object, including machine learning/neural-network models operative to automatically classify different objects. When using machine learning/neural-network models, the inference process may be executed on a purely visual input such as 3ped-image/s, or on an already processed input such as 3ped-GTD that includes 3D information and motion vectors.

In one embodiment, the generation 1generate3 of geo-temporal descriptions, such as the generation of 3ped-GTD, is done locally using a processor 1CPU onboard the edge device 1edge that is capturing the relevant sequences of imagery data 3ped-image/s. In such a case, the sequences of imagery data 3ped-image/s are aggregated and stored locally in the respective edge device for local machine learning/image processing.

In one embodiment, the generation 1generate3 of geo-temporal descriptions, such as the generation of 3ped-GTD, is done externally in a server 1 server/s that is in communicative contact with the edge device 1edge that is capturing the relevant sequences of imagery data 3ped-image/s. In such a case, the sequences of imagery data 3ped-image/s are sent over a communication network 1network from the edge device to the server for machine learning/image processing.

In one embodiment, the generation 1generate3 of geo-temporal descriptions, such as the generation of 3ped-GTD, is done cooperatively both locally using a processor 1CPU onboard the edge device 1edge that is capturing the relevant sequences of imagery data 3ped-image/s and externally in a server 1server/s that is in communicative contact with the edge device. In such a case, for example, the geometric/temporal aspects of generating the geo-temporal descriptions may be done locally in the edge device, while the functional description aspects of generating the geo-temporal descriptions may be done in the server after receiving pre-processed and/or post-processed data from the edge device.

FIG. 2C illustrates one embodiment of an association made between the dynamic and quasi-static objects at the semantic and geometric level. After a quasi-static geo-functional description of a quasi-static object was constructed, usually over long periods of image-capturing time, a real-time, near-real time, or post-real-time processing can be made to detect and classify events involving a dynamic object interacting with the quasi-static object. For example, after 4cross-QSGFD was generated from imagery captured over a period of more than one day, a description of a geometric location of the respective crosswalk 4cross, using a 3D representation of the crosswalk including 3D spatial coordinates 4cross-3D-coordinate, is now available. In addition, a functional description/classification 4cross-classification of the respective crosswalk is also now available. Now, when a pedestrian 3ped decides to cross the street (FIG. 1A), during (real-time), immediately after (e.g., several seconds after), or sometime after (e.g., several minutes after) capturing a sequences showing the pedestrian crossing, e.g., the sequence 3ped-image/s, the sequences are processed to generate 1generate3 a geo-temporal description 3ped-GTD of the pedestrian 3ped crossing, including a geometric/temporal description of geometrically changing-location of the respective pedestrian 3ped: e.g., using a 3D representation of the pedestrian including 3D spatial coordinates 3ped-3D-coordinate and using a motion vector 3ped-motion-vector, and including a description/classification 3ped-classification of the respective pedestrian 3ped as being a walking human. This recently-generated geo-temporal description 3ped-GTD is then compared/correlated 34associate3D with the previously-available quasi-static geo-functional description 4cross-QSGFD of the crosswalk 4cross, and a conclusion is made that an event of a pedestrian 3ped crossing over a crosswalk 4cross in now happening, has been happening, or has recently happened.

The comparison/correlation 34associate3D of recently-generated 3ped-GTD with the previously-available 4cross-QSGFD is made at two levels. The first level is a geo-spatial level, in which geo-spatial coordinates of the dynamic object are correlated with the geo-spatial coordinates of the quasi-static object. For example, the geo-spatial coordinates 3ped-3D-coordinate is correlated with the geo-spatial coordinates 4cross-3D-coordinate to determine physical proximity/contact between the pedestrian 3ped and the crosswalk 4cross. The second level is a semantic level, in which the type of the dynamic object is matched with the type of quasi-static object. For example, the classification 4cross-classification of 4cross-GSGFD as a “crosswalk” and the classification 3ped-classification of 3ped-GTD as a “human” are combined to reach the conclusion that pedestrian 3ped in crossing the street over crosswalk 4cross. It is noted that the two levels of comparison/correlation are necessary to conclude a “crossing event”, as it is first necessary to conclude that the two objects are in close proximity, and to then conclude that the types of objects facilitate a crossing event.

In one embodiment, a detection of an interaction event, such as the “crossing event”, may include various additional conclusions. For example, by further analyzing the geo-spatial information of the two objects, e.g., 3ped-3D-coordinate and 4cross-3D-coordinate, a conclusion can be made that the pedestrian 3ped is “missing” the markings of the crosswalk 4cross, and an appropriate action can be taken, e.g., announcing nearby vehicles 3car that a pedestrian is crossing in a dangerous manner.

In one embodiment, the detection and classification of events involving a dynamic object interacting with the quasi-static object is done in the edge devices 1edge using locally available computational capabilities 1cpu. In one embodiment, the detection and classification of events involving a dynamic object interacting with the quasi-static object is done in a remote server 1server/s. In such as case, the previously-available quasi-static geo-functional description, e.g., 4cross-QSGFD, is stored in the server 1server/s, the recently-generated geo-temporal description, e.g., 3ped-GTD, is sent in real-time, or near real-time, from the respective edge device 1edge to the server 1server/s, and, for example, the comparison/correlation 34associate3D of recently-generated 3ped-GTD with the previously-available 4cross-QSGFD is done in the server 1server/s. Other distribution of processing tasks may be possible between the edge devices 1edge and the server 1server/s.

One embodiment is a system operative to generate geo-temporal descriptions of dynamic objects and associate the geo-temporal descriptions with quasi-static geo-functional descriptions of quasi-static objects in a certain area, comprising: a plurality of edge devices 1edge (FIG. 1A), each comprising at least one optical sensor 1sens (FIG. 1B) operative to capture imagery data, in which the plurality of edge devices are located respectively at a plurality of different locations so as to result in at least partial visual coverage of the certain area 1area (FIG. 1A); and a server 1server/s (FIG. 1C) associated with the edge devices 1edge.

In one embodiment, the system is configured to: generate (e.g., 1generate4, FIG. 2A) the quasi-static geo-functional descriptions (e.g., 4cross-QSGFD, FIG. 2A) of at least some of the quasi-static objects 4struc, 4road, 4sidewalk, 4cross, 4sign, 4tree, 4pole, 4cable (FIG. 1A) in the certain area 1area using the imagery data (e.g., 4cross-image/s, FIG. 2A) captured by the edge devices 1edge and accumulated over a certain period of time; further generate, in real time (e.g., 1generate3, FIG. 2B), the geo-temporal descriptions (e.g., 3ped-GTD, FIG, 2B) of at least some of the dynamic objects 3car, 3ped (FIG. 1A) using current imagery data (e.g., 3ped-image/s, FIG. 2B) captured by the edge devices 1edge; and associate (e.g., 34associate3D, FIG. 2C) said geo-temporal descriptions with the geo-functional description, thereby establish geo-temporal interactions of the dynamic objects with the quasi static objects in the certain area.

In one embodiment, in conjunction with said generation of the quasi-static geo-functional description (e.g., 4cross-QSGFD), per each of at least some of the edge devices 1edge, the system is configured to: detect and at least partially classify the quasi-static objects 4struc, 4road, 4sidewalk, 4cross, 4sign, 4tree, 4pole, 4cable that appear in the imagery data captured by the respective optical sensor 1sens, in which said classification reveals a functional purpose of the quasi-static objects; and estimate spatial positions (e.g., 4cross-3D-coordinate, FIG. 2A) of each of the quasi-static objects detected, in which said estimation is expressed using a data format comprising at least one of: (i) a 3D point cloud, (ii) vectors, and/or (iii) polygon mesh.

In one embodiment, said estimation of the spatial positions of the quasi-static objects detected (e.g., 4cross-3D-coordinate) is at least partially based on an estimated spatial position of the respective edge device (e.g., 1edge3) together with additional information associated with the respective imagery data (e.g., 4cross-image/s).

In one embodiment, the additional information comprises at least one of: (i) depth information of points in the quasi-static objects relative to the respective edge device, and/or (ii) angular information of points in the quasi-static objects relative to the respective edge device, in which the respective optical sensor/s (e.g., 1sens of 1edge3) are of a type comprising at least one of: (i) a stereographic camera type, (ii) a RGB-Depth type, (iii) a single-camera type with machine-learning depth estimation, and/or (iv) a lidar type, and in which the estimation of the spatial position of the edge device (e.g., 1edge3) is done using a GNSS receiver (e.g., 1GNSS of 1edge3), such as a GPS receiver, co-located with the edge device.

In one embodiment, said estimation of the spatial positions of the quasi-static objects detected (e.g., 4cross-3D-coordinate) is at least partially based on correlating the captured imagery data of the quasi-static objects (e.g., 4cross-image/s) with appearances of the quasi-static objects in a geo-spatially tagged imagery data of an external source, in which said external source comprises at least one of: (i) satellite imagery, (ii) imagery captured by airborne platforms, and/or (iii) imagery captured by on-road mobile platforms such as vehicles.

In one embodiment, at least one of the quasi-static objects is at least a portion of a road 4road, and the geo-functional description of said portion of the road comprises: at least spatial locations of a set of borders defining said portion of the road; and an identification of the portion of the road as being a road and functional for supporting vehicular traffic and pedestrian movement.

In one embodiment, at least one of the quasi-static objects is at least a portion of a sidewalk 4sidewalk, and the geo-functional description of said portion of the sidewalk comprises: at least spatial locations of a set of borders defining said portion of the sidewalk; and an identification of the portion of the sidewalk as being a sidewalk and functional for supporting pedestrian movement.

In one embodiment, at least one of the quasi-static objects is a crosswalk markings 4cross on a road 4road, and the geo-functional description 4cross-QSGFD of said crosswalk markings comprises: at least spatial locations of a set of borders defining said crosswalk markings 4cross-3D-coordinate; and an identification of the crosswalk markings 4cross as being a crosswalk and functional for supporting pedestrians crossing a road.

In one embodiment, at least one of the quasi-static objects is a pole 4pole and related structures associated with at least one of: (i) a traffic light, (ii) a traffic sign 4sign, (iii) street illumination, and/or (iv) power lines and/or telephone cables 4cable, and the geo-functional description of said pole comprises: at least spatial locations of a vertical construct defining said pole; and an identification of the pole as being of a certain functional type.

In one embodiment, at least one of the quasi-static objects is a structure 4struc associated with at least one of: (i) a building, and/or (ii) a utility device, and the geo-functional description of said structure comprises: at least a three-dimensional representation of a border defining the structure; and an identification of the structure as being of a certain functional type.

In one embodiment, per each of at least some of the imagery data captured by the edge devices (e.g., 4cross-image/s), the system is further configured to detect, over said certain period of time, multiple substantially unchanged appearances of the quasi-static objects (e.g., 4cross), thereby ascertaining a quasi-static nature of the objects, in which said certain period of time is at least long enough to substantially eliminate temporary visual obstructions created by at least some of the dynamic objects 3car, 3ped.

In one embodiment, as part of said generation of the quasi-static geo-functional description (e.g., 4cross-QSGFD), each of at least some of the edge devices (e.g., 1edge3) is configured to generate, using a respective embedded computer (e.g., 1cpu of 1edge3, FIG. 1B), a three-dimensional geo-description of the respective quasi-static objects detected (e.g., 4cross-3D-coordinate), in which said three-dimensional geo-description comprises at least one of: (i) a 3D point cloud, (ii) vectors, and/or (iii) polygon mesh, and further comprises the respective estimated spatial positions; the edge devices 1edge are communicatively interconnected to the server 1server/s via a wireless mesh network 1network (FIG. 1C) having a finite bandwidth; each of at least some of the edge 1edge devices is further configured to send the respective three-dimensional geo-descriptions via the wireless mesh network to the server; and the server is configured to receive and combine the three-dimensional geo-descriptions from the edge devices, thereby facilitating said generation of the quasi-static geo-functional description of the certain area; in which a locally captured and stored instance of the imagery data (e.g., 4cross-image/s), which is used by the edge devices to locally generate the three-dimensional geo-descriptions of the quasi-static objects, is at least one-thousand times larger than a size of the respective three-dimensional geo-descriptions generated locally (e.g., 4cross-3D-coordinate), thereby further facilitating said generation of the quasi-static geo-functional description of the certain area by the server without congesting the wireless mesh network.

In one embodiment, in conjunction with said further generation of the geo-temporal descriptions (e.g., 3ped-GTD) of at least some of the dynamic objects (e.g., 3ped), each of at least some of the edge devices 1edge is configured to: detect and at least partially classify in real time, using a machine-learning-enabled computer 1cpu embedded in the edge device, dynamic objects that appear in the imagery data (e.g., 3ped-image/s) captured in real time by the respective optical sensor 1sens, in which said classification identifies the dynamic object as being at least one of: (i) a vehicle 3car, (ii) a pedestrian 3ped, and/or (iii) a flying natural or artificial object; and estimate at least one of: (i) spatial positions of each of the dynamic objects detected (e.g., 3ped-3D-coordinate, FIG. 2B), and/or (ii) movement vectors (e.g., 3ped-motion-vector, FIG. 2B) associated with the dynamic objects detected.

In one embodiment, said estimation of the spatial positions and/or movement vectors of the dynamic objects detected is at least partially based on an estimated spatial position of the respective edge device 1edge together with additional information associated with the respective imagery data, in which the additional information comprises at least one of: (i) depth information of points in the dynamic objects relative to the respective edge device, and/or (ii) angular information of points in the dynamic objects relative to the respective edge device, in which the respective optical sensor/s 1sens are of a type comprising at least one of: (i) a stereographic camera type, (ii) a RGB-Depth type, (iii) a single-camera type with machine-learning depth estimation, and/or (iv) a lidar type, and in which the estimation of the spatial position of the edge device is done using a GNSS receiver 1GNSS, such as a GPS receiver, co-located with the edge device.

In one embodiment, one of the edge devices 1edge2 that has just detected and classified one of the dynamic objects 3car is further configured to: characterize the dynamic object so as to allow further identification of that specific dynamic object by other edge devices; and send the characterization data over a communication interface 1comm (FIG. 1B), 1network to at least an adjacent edge device 1edge3; in which the adjacent edge device is configured to receive and use said characterization data to identify the specific dynamic object 3car when it enters a visual coverage area of the adjacent edge device, thereby tracking movement of the specific dynamic object across at least two edge devices 1edge2, 1edge3, and in which the characterization data comprises at least one of: (i) colors, (ii) shapes, (iii) movement behavior, (iv) a machine learning model, and/or (v) facial markers.

In one embodiment, said communication interface 1comm, 1network is a bandwidth-limited wireless mesh interconnecting the edge devices 1edge, and therefore said characterization data comprises less than one-hundred kilobytes in order to avoid congesting the wireless mesh.

In one embodiment, in conjunction with said association 34associate3D of the geo-temporal descriptions with the geo-functional description, per each of at least some of the edge devices and associated imagery data, the system is configured to: estimate spatial positions of each of the dynamic objects detected; compare said spatial positions of each of the dynamic objects detected (e.g., 3ped-3D-coordinate) to spatial positions of each of the quasi-static objects detected (e.g., 4cross-3D-coordinate); and conclude, based on said comparison, that a certain dynamic object is currently interacting with a certain quasi-static object.

In one embodiment, one of the quasi-static objects is a crosswalk 4cross; one of the dynamic objects is a pedestrian 3ped; and said conclusion is that the pedestrian is crossing a road over the crosswalk.

In one embodiment, one of the quasi-static objects is a sidewalk 4sidewalk and/or a road 4road with no parking markings; one of the dynamic objects is an on-road vehicle 3car; and said conclusion is that the on-road vehicle has just parked in a non-parking area.

In one embodiment, one of the quasi-static objects is a shop 4struc; one of the dynamic objects is a pedestrian 3ped; and said conclusion is that the pedestrian has just entered the shop.

In one embodiment, said visual coverage of the certain area 1area is partial, thereby resulting in coverage gaps, in which at least one of the quasi-static objects extends from one coverage zone of a first edge device into a coverage gap and then into a coverage zone of a second edge device, thereby resulting in a partial geo-functional description of that quasi-static object; and the system is further configured to extrapolate the partial geo-functional description by using machine learning techniques to fill gaps in the partial geo-functional description, thereby assisting in generating a complete geo-functional description of the certain area.

In one embodiment, said one of the quasi-static objects is a road 4road; the plurality of edge devices 1edge1, 1edge2 are placed in a sequence on poles along the road; and said extrapolation of the partial geo-functional description is operative to fill gaps in the geo-functional description of the road, thereby resulting in a complete and continuous geo-functional description of the road.

In one embodiment, said visual coverage of the certain area 1area is at least partially overlapping, thereby resulting in visual coverage of at least a portion of one of the quasi-static object (e.g., 4road) by at least two different edge devices 1edge1, 1edge2, thereby resulting in a better geo-functional description of that portion of the quasi-static object achieved at least in part by correlating imagery data from the at least two different edge devices and/or achieved at least in part by using triangulation techniques.

In one embodiment, the certain area 1area comprises at least one of: (i) an outdoor area comprising streets 4road, and/or (ii) an indoor area.

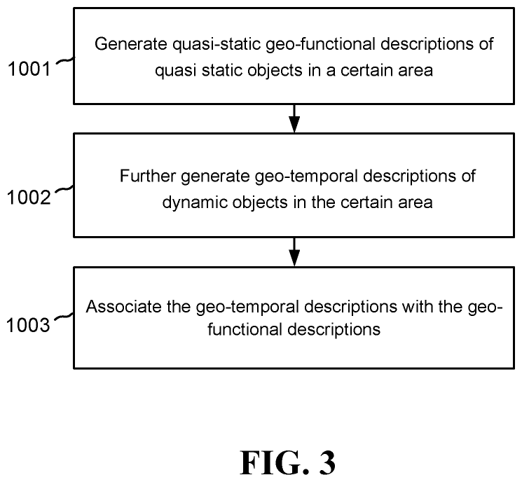

FIG. 3 illustrates one embodiment of a method for generating geo-temporal descriptions of dynamic objects and associating the geo-temporal descriptions with quasi-static geo-functional descriptions of quasi-static objects in a certain area.

The method includes: in step 1001, generating (e.g., 1generate4, FIG. 2A), by a plurality of edge devices in the certain area and a server, quasi-static geo-functional descriptions (e.g., 4cross-QSGFD, FIG. 2A) of at least some of the quasi-static objects 4struc, 4road, 4sidewalk, 4cross, 4sign, 4tree, 4pole, 4cable (FIG. 1A) in the certain area 1area using imagery data (e.g., 4cross-image/s, FIG. 2A) captured by the edge devices 1edge and accumulated over a certain period of time. In step 1002, further generating, in real time (e.g., 1 generate3, FIG. 2B), geo-temporal descriptions (e.g., 3ped-GTD, FIG. 2B) of at least some of dynamic objects 3car, 3ped (FIG. 1A) in the area using current imagery data (e.g., 3ped-image/s, FIG. 2B) captured by the edge devices 1edge. In step 1003, associating (e.g., 34associate3D, FIG. 2C) said geo-temporal descriptions with the geo-functional description, thereby establishing geo-temporal interactions of the dynamic objects with the quasi-static objects in the certain area.

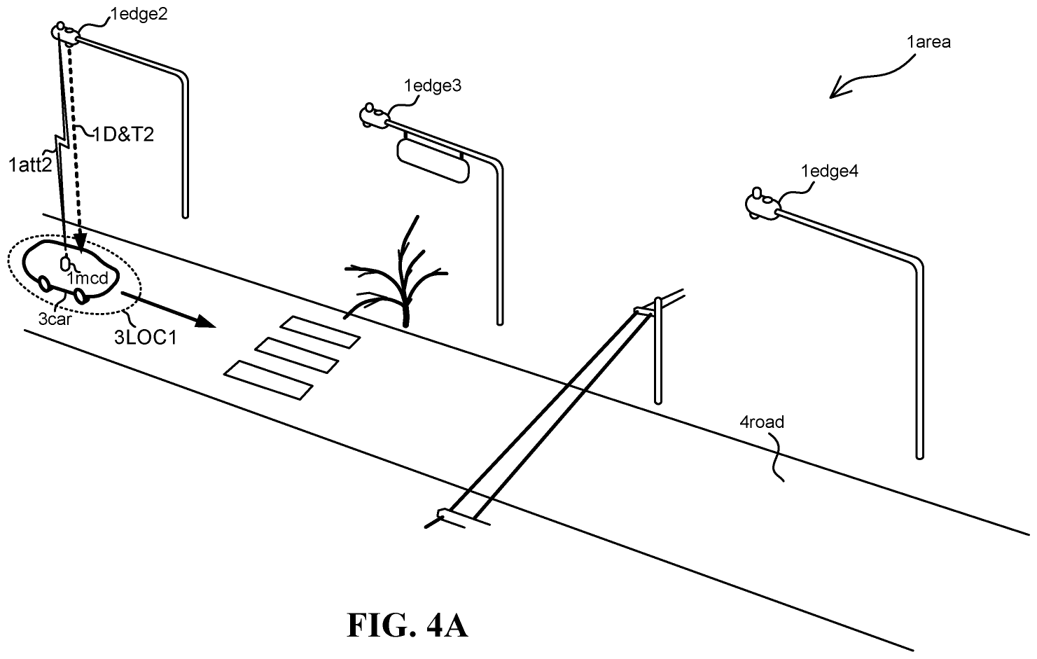

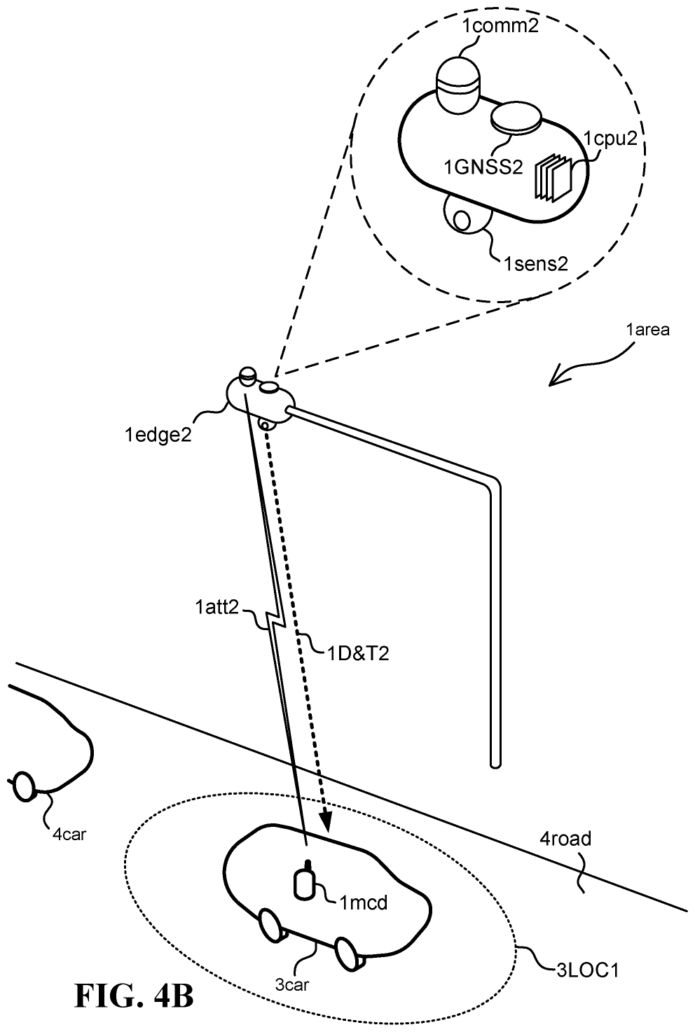

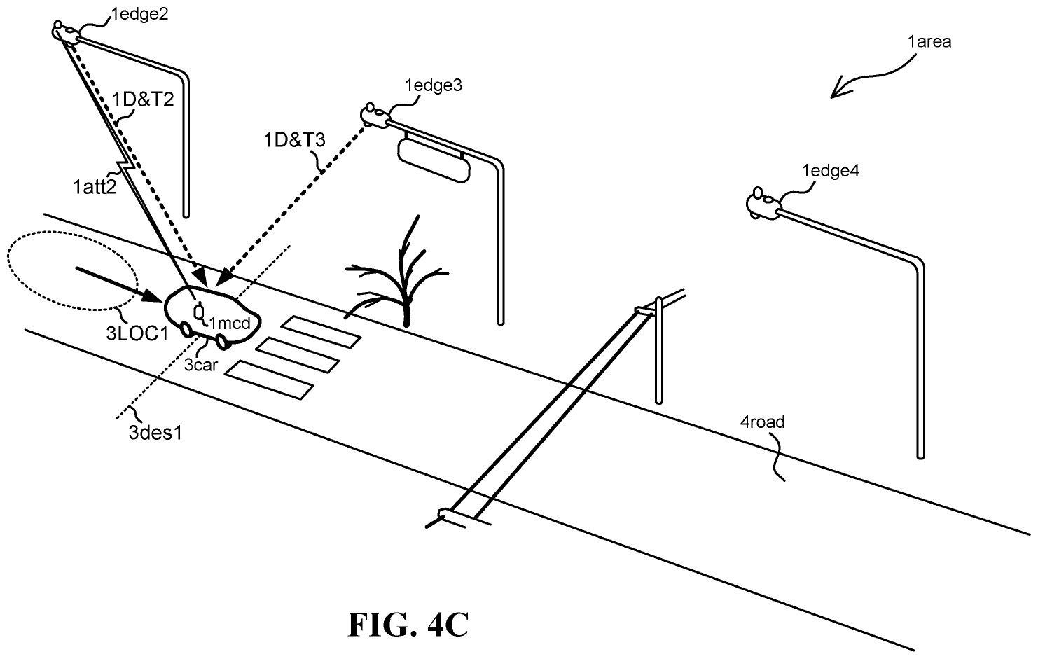

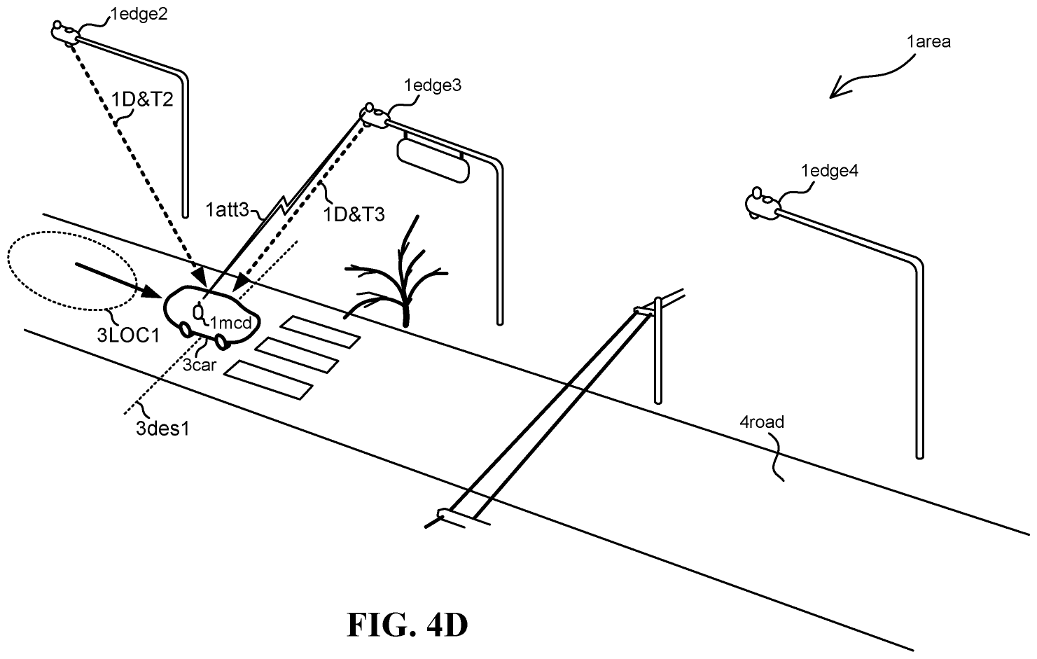

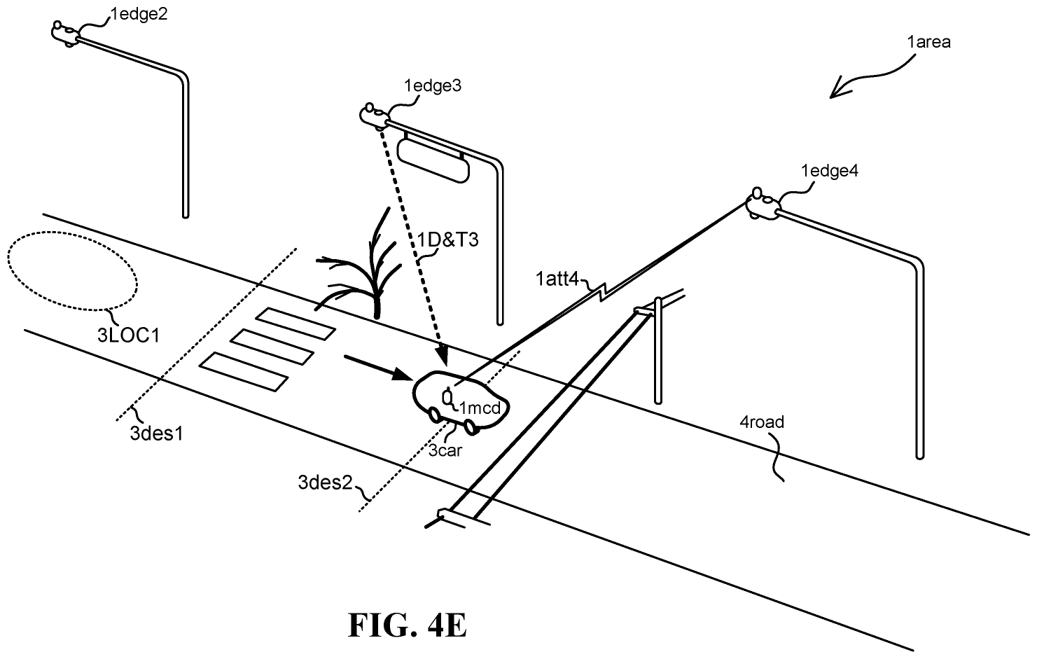

FIG. 4A illustrates one embodiment of a mobile device 1mcd that is currently attached to one 1edge2 of a series of base stations 1edge and that is located in a moving vehicle 3car that is being visually tracked 1D&T2 along a path of progression, e.g., along 4road. The mobile device 1mcd communicates with the outside world via base station 1edge2 that is one base station is a series of base stations 1edge belonging to a certain radio access network (RAN). The mobile device 1mcd needs to stay in a continuous communication with the outside world, e.g., maintain an undisrupted voice call, as 3car moves along 4road and switches between the different base stations on its way. In order to assist with a scenario in which frequent switching between the various base stations 1edge is required, e.g., when the distance between base stations is short, and/or when the vehicle travels fast, the RAN first tries to determine an exact location 3LOC1 of mobile device 1mcd. Determining an exact location 3LOC1 of 1mcd can be done in several ways, e.g., by asking 1mcd to use its onboard global navigation satellite system (GNSS) receiver to report current position to the RAN. After the exact location 3LOC1 of 1mcd is determined, the RAN tries to visually locate a moving object associated with 1mcd. For example, the RAN may use an array of cameras located along 4road to try and “look” at location 3LOC1 and detect a moving object. If the RAN “sees” that there is a moving car 3car in location 3LOC1, then it is highly probable that 1mcd is in the moving car. Now, when the RAN knows that 1mcd is in 3car, it can try to visually track 1D&T2, using the array of cameras, the moving object 3car along its path of progression, and consequently know the exact location of 1mcd at every point in time along said path of progression, in which such knowledge will be used next to assist with predicting a good location for performing a handover between the current base station 1edge2 to which 1mcd is currently attached and an adjacent base station 1edge3.

FIG. 4B illustrates one embodiment of the base station 1edge2 associated with a visual sensor 1sens2 that is being used to visually track 1D&T2 the vehicle 3car containing the mobile device 1mcd currently attached 1att2 to the base station 1edge2. Various other elements associated with the base station 1edge2 are shown, including a processor 1cpu2 that may assist with said tracking 1D&T2, a GNSS receiver 1GNSS2 that may assist in locating the base station 1edge2 relative to the vehicle 3car, and a communication element 1comm2 that is associated with RAN and backhaul functionality. A second vehicle 4car is shown as well, in which the accuracy of locating 3LOC1 the vehicle 3car is good enough to eliminate a possibility of erroneously assuming that 1mcd is located in 4car, and thereby eliminating a possibility of erroneously tracking 4car instead of tracking 1D&T2 the correct vehicle 3car.

FIG. 4C illustrates one embodiment of the moving vehicle 3car that has been visually tracked 1D&T2 to a specific location 3des1 that is known to be a good location for initiating a handover from the base station 1edge2 to which the mobile device 1mcd is currently attached 1att2 to an adjacent base station 1edge3.

FIG. 4D illustrates one embodiment of handing over of the mobile device 1mcd from one of the base stations 1edge2 to an adjacent base station 1edge3 while continuing with visually tracking 1D&T3 the vehicle 3car. It is noted that continuing with visually tracking 3car may be done using visual sensors onboard 1edge2, e.g., 1D&T2, or using visual sensors onboard 1edge3, e.g., 1D&T3, or using both sensors and/or other sensors. It is noted that visually tracking 3car may be “handed over” from 1edge2 to 1edge 3, e.g., the transition from 1D&T2 to 1D&T3, at the same time as the RAN handover is performed, e.g., at the same time of the transition from 1att2 to 1att3.

FIG. 4E illustrates one embodiment of the vehicle 3car visually tracked 1D&T3 to another location 3des2 that is known to be a good location for initiating another handover to the next base station 1edge4 in the series. After performing said another handover, e.g., after the transition from 1att3 to 1att4, the mobile device 1mcd is attached 1att4 to base station 1edge4, and the RAN may continue with visually tracking 3car1.

One embodiment is a system operative to utilize visual cues to predict handover events in conjunction with radio-access-networks, comprising: a plurality of network-enabled optical sensors 1sens (FIG. 1B) distributed across a certain geographical area 1area (FIG. 4) so as to facilitate visual coverage thereof, e.g., the sensor 1sens2 (FIG. 4B) belonging to base station 1edge2 (FIG. 4B) and similar sensors belonging to other base stations 1edge3, 1edge4 (FIG. 4A); and a first network-enabled computer 1server/s (FIG. 1C) communicatively connected to the visual sensors 1sens, in which the computer is operative to receive visual information from the optical sensors; and a second network-enabled computer 1server/s, which may be the same computer as the first computer or a different computer, communicatively connected to the first computer and operative to maintain communicative contact with various mobile client devices 1mcd (FIG. 4) currently attached to various base station nodes 1edge of a radio-access-network.

In one embodiment, the system is configured to: receive, in the second network-enabled computer 1server/s, via the radio-access-network, information regarding a current location 3LOC1 (FIG. 4A) of a specific one 1mcd of said mobile client devices currently on the move and currently attached 1att2 (FIG. 4A) to a particular one of the base station nodes 1edge2; process, in the first network-enabled computer 1server/s and in conjunction with said information regarding the current location 3LOC1 of the specific mobile client device 1mcd, the visual information received, and consequently visually detect and track 1D&T2 (FIG. 4A, FIG. 4B, FIG. 4C) movement associate with said specific mobile client device 1mcd that is on the move; and predict, using said visual tracking 1D&T2, and using at least one criterion, an exact time to initiate a handover operative to detach the specific mobile client device 1mcd from the particular base station node 1edge2 and to attach 1att3 (FIG. 4D) the specific mobile client device to a different one of the base station nodes 1edge3 (FIG. 4D).

In one embodiment, the system is further configured to: determine that said exact time has arrived; and initiate a handover, in conjunction with said exact time, thereby detaching the specific mobile client device 1mcd from the particular base station node 1edge2 and attaching 1att3 the specific mobile client device to the different one of the base station nodes 1edge3.

In one embodiment, as part of said visual detection 1D&T2, the system is configured to: use said information regarding the current location 3LOC1 of the specific mobile client device 1mcd to locate, in said visual information, a specific region in the span of visual information, that corresponds to said current location 3LOC1 of the specific mobile client device; detect, in said specific region located, a moving object, e.g., 3car (FIG. 4A); and assume that said moving object 3car detected is associated with the specific mobile client device 1mcd in conjunction with said visual tracking 1D&T2.

In one embodiment, as part of said visual tracking 1D&T2, the system is configured to track, using the visual information, said moving object 3car detected and assumed to be associated with the specific mobile client device 1mcd, across regions 4road (FIG. 4) in the span of visual information, until reaching a designated region 3des1 (FIG. 4C, FIG. 4D) that is associated with initiating the handover.

In one embodiment, said exact time is a time in which said moving object 3car detected, and assumed to be associated with the specific mobile client device 1mcd, has finally reached, and/or is about to reach, the designated region 3des1 that is associated with initiating the handover.

In one embodiment, said designated region 3des1, within the span of the visual information, is a region corresponding to a physical location that was previously determined to be an optimal location for performing said handover.

In one embodiment, said previous determination is based on at least one of: (i) trial an error done in conjunction with previous handovers, (ii) an analytical calculation based on wave propagation, and/or (iii) previously received signal strength indicator (RSSI) and/or reference signal received power (RSRP) measurements done in conjunction with the respective base station nodes 1edge2, 1edge3.

In one embodiment, the specific mobile client device 1mcd comprises at least one of: (i) a mobile client device within a vehicle 3car on the move and/or (ii) a mobile client device carried by a pedestrian on the move.

In one embodiment, at least some of the various base station nodes 1edge2, 1edge3, 1edge3 (FIG. 4) are arranged as a sequence of nodes having an average spacing of less than 100 (one hundred) meters between adjacent ones of the nodes, in which the particular one of the base station nodes 1edge2 and the different one of the base station nodes 1edge3, that are involved in said handover, are both two adjacent nodes in said sequence; the sequence of nodes is deployed alongside a road 4road; and the specific mobile client device 1mcd is located within the vehicle 3car traveling along the road 4road; in which the vehicle 3car is traveling at an average velocity that requires performing a sequence of handovers every less than 10 (ten) seconds, in which said handover is one of the sequence of handovers, and therefore the usage of said visual cues is critical to avoid interruptions in communication associated with said specific mobile client device 1mcd.

In one embodiment, at least some of the visual sensors 1sens are co-located, as a sequence, respectively with the sequence of base station nodes 1edge.

In one embodiment, at least some of the base station nodes 1edge are co-located with city-level infrastructure comprising at least one of: (i) lighting pole, (ii) traffic pole, and/or (iii) rooftops.

In one embodiment, at least some of the base station nodes 1edge are pico-cells, in which the pico-cells communicate with each other and/or with the two network-enabled computers 1server/s using a mesh communication topology.

In one embodiment, said information, regarding the current location 3LOC1 of the specific mobile client device 1mcd, is received, and then said prediction is made multiple times in conjunction with said sequence of handovers, before receiving another information regarding a new location of the specific mobile client device.

In one embodiment, said information regarding the current location LOC1 of the specific mobile client device 1mcd, received in the second network-enabled computer 1server/s, via the radio-access-network, comprises global navigation satellite system (GNSS) reading/s conveyed by the specific mobile client device.

In one embodiment, said information regarding the current location 3LOC1 of the specific mobile client device 1mcd, received in the second network-enabled computer 1server/s, via the radio-access-network, comprises triangulation of a position of the specific mobile client devices using radio-access-network timing measurements done in conjunction with the particular one of the base station nodes 1edge2 and the different one of the base station nodes 1edge3, that are involved in said handover.

In one embodiment, said radio-access-network is associated with at least one of: (i) 3G/4G/5G/6G cellular infrastructure, (ii) long-term-evolution (LTE) cellular infrastructure, and/or (iii) WiFi communication infrastructure.

In one embodiment, said specific mobile client device 1mcd comprise at least one of: (i) a smartphone, (ii) a laptop, and/or (iii) a communication device embedded in a vehicle 3car.

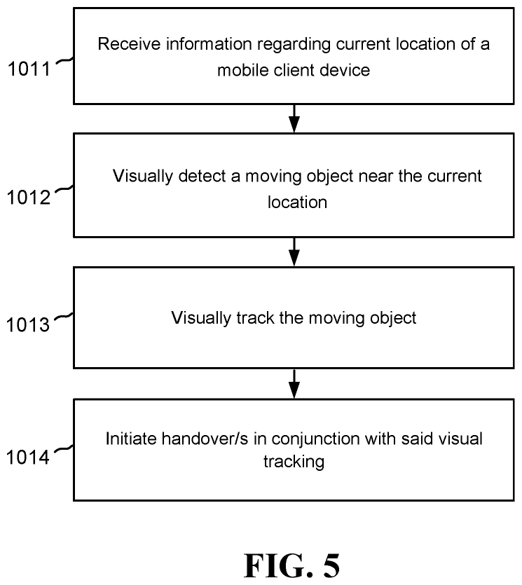

FIG. 5 illustrates one embodiment of a method for utilizing visual cues to predict handover events in conjunction with radio-access-networks.

In step 1011, receiving, in conjunction with a radio-access network associated with a sequence of base station nodes located along a certain path, e.g., nodes 1edge2, 1edge3, 1edge4 located along 4road, information regarding a current location 3LOC1 of a mobile client device 1mcd currently on the move along said path and currently attached to one of the base station nodes 1edge2.

In step 1012, detecting, using a sequence of visual sensors 1sens located along said path, a moving object, e.g., 3car, that is within no more than 10 (ten) meters from said current location 3LOC1, while assuming that the mobile client device 1mcd is in and/or with the moving object detected.

In step 1013, tracking, using the sequence of visual sensors 1sens, the moving object 3car along said path; and

In step 1014, initiating a sequence of handover events, in which each of the handover events is initiated when the moving object 3car has been tracked to arrive at one of a list of locations 3des1, 3des2 (FIG. 4E) along the path that are designated as handover locations.

In one embodiment, each of the handover locations 3des is a location between two of the base station nodes 1edge that are adjacent, e.g., 3des1 is located between 1edge2 and 1edge3, and 3des2 is located between 1edge3 and 1edge4, and that was previously determined to be an optimal location for performing a handover in conjunction with the respective two of the base station nodes.

In one embodiment, said moving object 3car requires a sequence of at least 10 (ten) handovers over a period of less than 100 (one hundred) seconds.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases.

Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor, but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system operative to generate geo-temporal descriptions of dynamic objects and associate the geo-temporal descriptions with quasi-static geo-functional descriptions of quasi-static objects in a certain area, comprising:
a plurality of edge devices, each comprising at least one optical sensor operative to capture imagery data, in which the plurality of edge devices are located respectively at a plurality of different locations so as to result in at least partial visual coverage of the certain area; and
a server associated with the edge devices;
wherein the system is configured to:
generate the quasi-static geo-functional descriptions of at least some of the quasi-static objects in the certain area using the imagery data captured by the edge devices and accumulated over a certain period of time;
further generate, in real time, the geo-temporal descriptions of at least some of the dynamic objects using current imagery data captured by the edge devices; and
associate said geo-temporal descriptions with the geo-functional description, thereby establishing geo-temporal interactions of the dynamic objects with the quasi-static objects in the certain area.

2. The system of claim 1, wherein in conjunction with said generation of the quasi-static geo-functional description, per each of at least some of the edge devices, the system is configured to:
detect and at least partially classify the quasi-static objects that appear in the imagery data captured by the respective optical sensor, in which said classification reveals a functional purpose of the quasi-static objects; and
estimate spatial positions of each of the quasi-static objects detected, in which said estimation is expressed using a data format comprising at least one of: (i) a 3D point cloud, (ii) vectors, and/or (iii) polygon mesh.

3. The system of claim 2, wherein said estimation of the spatial positions of the quasi-static objects detected is at least partially based on an estimated spatial position of the respective edge device together with additional information associated with the respective imagery data.

4. The system of claim 3, wherein the additional information comprises at least one of: (i) depth information of points in the quasi-static objects relative to the respective edge device and/or (ii) angular information of points in the quasi-static objects relative to the respective edge device, in which the respective optical sensor/s are of a type comprising at least one of: (i) a stereographic camera type, (ii) an RGB-Depth type, (iii) a single-camera type with machine-learning depth estimation, and/or (iv) a lidar type, and in which the estimation of the spatial position of the edge device is done using a global navigation satellite system (GNSS) receiver co-located with the edge device.

5. The system of claim 2, wherein said estimation of the spatial positions of the quasi-static objects detected is at least partially based on correlating the captured imagery data of the quasi-static objects with appearances of the quasi-static objects in a geo-spatially tagged imagery data of an external source, in which said external source comprises at least one of: (i) satellite imagery, (ii) imagery captured by airborn platforms, and/or (iii) imagery captured by on-road mobile platforms.

6. The system of claim 2, wherein at least one of the quasi-static objects is at least a portion of a road, and the geo-functional description of said portion of the road comprises:
at least spatial locations of a set of borders defining said portion of the road; and
an identification of the portion of the road as being a road and functional for supporting vehicular traffic and pedestrian movement.

7. The system of claim 2, wherein at least one of the quasi-static objects is at least a portion of a sidewalk, and the geo-functional description of said portion of the sidewalk comprises:
at least spatial locations of a set of borders defining said portion of the sidewalk; and
an identification of the portion of the sidewalk as being a sidewalk and functional for supporting pedestrian movement.

8. The system of claim 2, wherein at least one of the quasi-static objects is a crosswalk markings on a road, and the geo-functional description of said crosswalk markings comprises:
at least spatial locations of a set of borders defining said crosswalk markings; and
an identification of the crosswalk markings as being a crosswalk and functional for supporting pedestrians crossing a road.

9. The system of claim 2, wherein at least one of the quasi-static objects is a pole and related structures associated with at least one of: (i) a traffic light, (ii) a traffic sign, (iii) street illumination, and/or (iv) power lines and/or telephone cables, and the geo-functional description of said pole comprises:
at least spatial locations of a vertical construct defining said pole; and
an identification of the pole as being of a certain functional type.

10. The system of claim 2, wherein at least one of the quasi-static objects is a structure associated with at least one of: (i) a building and/or (ii) a utility device, and the geo-functional description of said structure comprises:
at least a three-dimensional representation of a border defining the structure; and
an identification of the structure as being of a certain functional type.

11. The system of claim 2, wherein per each of at least some of the imagery data captured by the edge devices, the system is further configured to detect, over said certain period of time, multiple substantially unchanged appearances of the quasi-static objects, thereby ascertaining a quasi-static nature of the objects, in which said certain period of time is at least long enough to substantially eliminate temporary visual obstructions created by at least some of the dynamic objects.

12. The system of claim 2, wherein:
as part of said generation of the quasi-static geo-functional description, each of at least some of the edge devices is configured to generate, using a respective embedded computer, a three-dimensional geo-description of the respective quasi-static objects detected, in which said three-dimensional geo-description comprises at least one of: (i) a 3D point cloud, (ii) vectors, and/or (iii) a polygon mesh, and further comprises the estimated spatial positions;
the edge devices are communicatively interconnected to the server via a wireless mesh network having a finite bandwidth;
each of at least some of the edge devices is further configured to send the three-dimensional geo-description from each edge device via the wireless mesh network to the server; and
the server is configured to receive and combine the three-dimensional geo-description from each edge device, thereby facilitating said generation of the quasi-static geo-functional description of the certain area;
in which a locally captured and stored instance of the imagery data, which is used by the edge devices to locally generate the three-dimensional geo-descriptions of the quasi-static objects, is at least one-thousand times larger than a size of the respective three-dimensional geo-descriptions generated locally, thereby further facilitating said generation of the quasi-static geo-functional description of the certain area by the server without congesting the wireless mesh network.

13. The system of claim 1, wherein in conjunction with said further generation of the geo-temporal descriptions of at least some of the dynamic objects, each of at least some of the edge devices is configured to:
detect in and at least partially classify in real time, using a machine-learning-enabled computer embedded in the edge device, dynamic objects that appear in the imagery data captured in real time by the respective optical sensor, in which said classification identifies the dynamic object as being at least one of: (i) a vehicle, (ii) a pedestrian, and/or (iii) a flying natural or artificial object; and
estimate at least one of: (i) spatial positions of each of the dynamic objects detected and/or (ii) movement vectors associated with the dynamic objects detected.

14. The system of claim 13, wherein said estimation of the spatial positions and/or movement vectors of the dynamic objects detected is at least partially based on an estimated spatial position of the respective edge device together with additional information associated with the respective imagery data, in which the additional information comprises at least one of: (i) depth information of points in the dynamic objects relative to the respective edge device and/or (ii) angular information of points in the dynamic objects relative to the respective edge device, in which the respective optical sensor/s are of a type comprising at least one of: (i) a stereographic camera type, (ii) a RGB-Depth type, (iii) a single-camera type with machine-learning depth estimation, and/or (iv) a lidar type, and in which the estimation of the spatial position of the edge device is done using a global navigation satellite system (GNSS) receiver co-located with the edge device.

15. The system of claim 13, wherein one of the edge devices that has just detected and classified one of the dynamic objects is further configured to:
characterize the dynamic object so as to allow further identification of that specific dynamic object by other edge devices; and
send the characterization data over a communication interface to at least an adjacent edge device;
in which the adjacent edge device is configured to receive and use said characterization data to identify the specific dynamic object when it enters a visual coverage area of the adjacent edge device, thereby tracking movement of the specific dynamic object across at least two edge devices, and in which the characterization data comprises at least one of: (i) colors, (ii) shapes, (iii) movement behavior, (iv) a machine learning model, and/or (v) facial markers.

16. The system of claim 15, wherein said communication interface is a bandwidth-limited wireless mesh interconnecting the edge devices, and therefore said characterization data comprises less than one-hundred kilobytes in order to avoid congesting the wireless mesh.

17. The system of claim 1, wherein in conjunction with said association of the geo-temporal descriptions with the geo-functional description, per each of at least some of the edge devices and associated imagery data, the system is configured to:
estimated spatial positions of each of the dynamic objects detected;
compare said spatial positions of each of the dynamic objects detected to spatial positions of each of the quasi-static objects detected; and
conclude, based on said comparison, that a certain dynamic object is currently interacting with a certain quasi-static object.

18. The system of claim 17, wherein:
one of the quasi-static objects is a crosswalk;
one of the dynamic objects is a pedestrian; and
said conclusion is that the pedestrian is crossing a road over the crosswalk.

19. The system of claim 17, wherein:
one of the quasi-static objects is a sidewalk and/or a road with no parking markings;
one of the dynamic objects is an on-road vehicle; and
said conclusion is that the on-road vehicle has just parked in a non-parking area.

20. The system of claim 17, wherein:
one of the quasi-static objects is a shop;
one of the dynamic objects is a pedestrian; and
said conclusion is that the pedestrian has just entered the shop.

21. The system of claim 1, wherein:
said visual coverage of the certain area is partial, thereby resulting in coverage gaps, in which at least one of the quasi-static objects extends from one coverage zone of a first edge device into a coverage gap and then into a coverage zone of a second edge device, thereby resulting in a partial geo-functional description of that quasi-static object; and
the system is further configured to extrapolate the partial geo-functional description by using machine-learning techniques to fill gaps in the partial geo-functional description, thereby assisting in generating a complete geo-functional description of the certain area.

22. The system of claim 21, wherein:
said one of the quasi-static objects is a road;
the plurality of edge devices are placed in a sequence on poles along the road; and
said extrapolation of the partial geo-functional description is operative to fill gaps in the geo-functional description of the road, thereby resulting in a complete and continuous geo-functional description of the road.

23. The system of claim 1, wherein said visual coverage of the certain area is at least partially overlapping, thereby resulting in visual coverage of at least a portion of one of the quasi-static object by at least two different edge devices, thereby resulting in a better geo-functional description of that portion of the quasi-static object achieved at least in part by correlating imagery data from the at least two different edge devices and/or achieved at least in part by using triangulation techniques.

24. The system of claim 1, wherein the certain area comprises at least one of: (i) an outdoor area comprising streets and/or (ii) an indoor area.

25. A method for generating geo-temporal descriptions of dynamic objects and associating the geo-temporal descriptions with quasi-static geo-functional descriptions of quasi-static objects in a certain area, comprising:
generating, by a plurality of edge devices in the certain area and a server, quasi-static geo-functional descriptions of at least some of the quasi-static objects in the certain area using imagery data captured by the edge devices and accumulated over a certain period of time;
further generating, in real time, geo-temporal descriptions of at least some of dynamic objects in the area using current imagery data captured by the edge devices; and
associating said geo-temporal descriptions with the geo-functional description, thereby establishing geo-temporal interactions of the dynamic objects with the quasi-static objects in the certain area.
